(19) United States
(12) Patent Application Publication
(10) Pub. No.: US 2025/0265525 A1
(43) Pub. Date: Aug. 21, 2025

(54) INFORMATION PROCESSING DEVICE, INFORMATION PROCESSING METHOD, AND INFORMATION PROCESSING SYSTEM

(71) Applicant: Toshiba Tec Kabushiki Kaisha, Tokyo (JP)

(72) Inventor: Kazuhiro KAMIMURA, Mishima Shizuoka (JP)

(73) Assignee: Toshiba Tec Kabushiki Kaisha, Tokyo (JP)

(21) Appl. No.: 19/054,496

(22) Filed: Feb. 14, 2025

(30) Foreign Application Priority Data
Feb. 16, 2024 (JP) 2024-021889

(51) Int. Cl. G06Q 10/0633; G06Q 10/0639

(52) U.S. Cl. CPC G06Q 10/0633; G06Q 10/06395

(57) ABSTRACT

According to at least one embodiment, an information processing device includes one or more processors. The one or more processors acquire execution history information of a workflow. The one or more processors determine an item for which work support is to be performed based on the execution history information. The one or more processors perform a work support process for the item.

### CROSS-REFERENCE TO RELATED APPLICATION

This application is based upon and claims the benefit of priority from Japanese Patent Application No. 2024-021889, filed on Feb. 16, 2024, the entire contents of which are incorporated herein by reference.

### FIELD

Embodiments described herein relate generally to an information processing device, an information processing method, and an information processing system.

### BACKGROUND

In a workflow system that circulates document data, for example, when an application form is generated, a drafter inputs information by using a pull-down menu to select multiple options or enters text in free description. When the drafter completes the work, the document data is circulated to a checker, an approver, or the like in accordance with a circulation route.

In conventional workflow systems, when a drafter is unexperienced or inexperienced with workflows, the drafter may input errors may when entering information, and document data or the like may be returned by a worker of the succeeding order, which may result in needing corrections. Although input errors caused by the drafter can be detected by a check performed by the worker of the succeeding order such as an approver, it is difficult to mitigate errors due to the manual process of the workflow. Consequently, there is a demand for an operation support system that can perform work support for making it less likely to cause errors even when workflows are used by unexperienced or inexperienced people.

### DESCRIPTION OF THE DRAWINGS

FIG. 1 is a block diagram illustrating an operation support system according to an embodiment;

FIG. 2 is a diagram illustrating an example of an input image displayed on a first user terminal;

FIG. 3 is a flowchart illustrating an example of a procedure of information processing related to a support process performed by a server;

FIG. 4 is a flowchart illustrating another example of a procedure of information processing related to a support process performed by the server;

FIG. 5 is a flowchart illustrating still another example of a procedure of information processing related to a support process performed by the server; and

FIG. 6 is a flowchart illustrating an example of a procedure of information processing related to an experience value obtained by the server.

### DETAILED DESCRIPTION

The present disclosure provides embodiments including an information processing device, an information processing method, and an information processing system which can perform work support.

In general, according to at least one embodiment, an information processing device includes one or more processors. The information processing device may also include an acquisition unit (e.g., an acquirer), a determination unit (e.g., a determiner), and a support processing unit (e.g., a support processor). The one or more processors acquire execution history information of a workflow. The one or more processors determine an item for which work support is to be performed based on the execution history information. The one or more processors perform a work support process for the item.

### Embodiment

An embodiment will be described below with reference to the drawings. In the drawings, the same components are given the same reference numerals as much as possible, and repeated descriptions will be omitted.

### Configuration Example

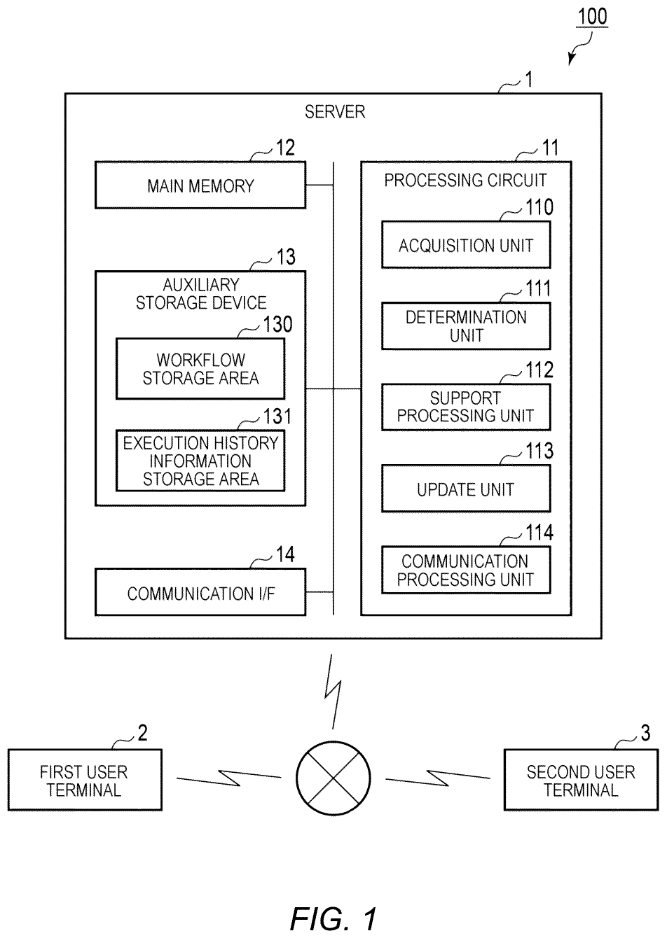

FIG. 1 is a block diagram illustrating an operation support system 100 according to the embodiment.

The operation support system 100 includes a server 1, a first user terminal 2, and a second user terminal 3. The server 1, the first user terminal 2, and the second user terminal 3 are connected to each other via a network so as to be able to communicate with each other. For example, the network is configured with one or more networks among various networks such as the Internet, a mobile communication network, and a local area network (LAN). The one or more networks may include a wireless network or a wired network. The operation support system 100 may also refer to a system including at least two apparatuses among the server 1, the first user terminal 2, and the second user terminal 3.

The server 1 is a device that collects data and processes the collected data. The server 1 is communicatively connected to the first user terminal 2 and the second user terminal 3 via the network. The server 1 receives various data from the first user terminal 2 and the second user terminal 3, and outputs various data to the first user terminal 2 and the second user terminal 3. The server 1 is an example of an information processing device. An example of the configuration of the server 1 will be described further herein. The server 1 may be a server used in a cloud service.

The server 1 provides a workflow service for performing processes such as generation of an application form or the like to approval or settlement. The workflow service provides, for example, a workflow for generating and managing document data. The workflow includes a series of tasks in which a drafter generates document data and circulates the document data to a worker of the succeeding order (e.g., a checker) in accordance with a predetermined circulation route. The generation of the document data includes inputting information (e.g., necessary information), attaching documents (e.g., necessary documents), and the like. The circulation includes notifying the worker of the succeeding order. The worker of the succeeding order confirms the document data generated by the drafter. The worker of the succeeding order may include a checker, an approver, and the like. The checker and the approver are also referred to as a confirmer. The workflow service may include a plurality of workflows. A workflow is, for example, set for each operation that can be viewed or worked on by a plurality of workers within an organization. The organization may include workers who perform work from the start to the completion of a workflow. The organization may be, for example, a company, a business, or an office. The organization is not limited to those mentioned above and may be a community that includes a plurality of workers. A workflow may include, for example, a series of tasks such as drafting, approval, and settlement. The workflow may include, for example, the generation of various application forms for, for example, travel expense applications and facility use applications, the generation of a report, and the generation of a written request. The workflow may include information sharing within an organization. The workflow may be set for each operation, task, or topic.

The first user terminal 2 is an apparatus that can communicate with other electronic apparatuses. The first user terminal 2 is an apparatus used by the drafter of the workflow. The drafter is also referred to as a generator of document data in the workflow. For example, the first user terminal 2 is a personal computer (PC), a smartphone, a tablet terminal, or the like, but is not limited thereto. A user of the first user terminal 2 uses a workflow service via the first user terminal 2. The user of the first user terminal 2 may be read as a worker of the preceding order, a drafter, a generator, an applicant, a worker, or a person.

The second user terminal 3 is an apparatus that can communicate with other electronic apparatuses, such as being communicatively coupled with other electronic apparatuses. The second user terminal 3 is an apparatus used by a worker of the succeeding order. The worker of the succeeding order is, for example, a checker or an approver. The second user terminal 3 is a PC, a smartphone, a tablet terminal, or the like. A user of the second user terminal 3 may be read as a worker of the succeeding order, a checker, an approver, a confirmer, a worker, or a person.

An example of the configuration of the server 1 will be described.

The server 1 is an apparatus that includes a processing circuit 11 (e.g., processor), a main memory 12, an auxiliary storage device 13, and a communication interface 14. Parts that configure the server 1 are connected to each other so that signals can be input and output. In FIG. 1, the interface is written as “I/F”.

The processing circuit 11 is equivalent (e.g., corresponds) to the central part of the server 1. The processing circuit 11 is an element that configures a computer of the server 1. For example, the processing circuit 11 is a central processing unit (CPU), but is not limited thereto. The processing circuit 11 may be configured with various circuits. The processing circuit 11 loads a program that is stored in advance in the main memory 12 or the auxiliary storage device 13 into the main memory 12. The program is a program that causes the processing circuit 11 of the server 1 to implement each part to be described below. The processing circuit 11 executes various operations by executing the program loaded into the main memory 12.

The main memory 12 is equivalent to a main memory part of the server 1. The main memory 12 is an element that configures the computer of the server 1. The main memory 12 includes a non-volatile memory area and a volatile memory area. The main memory 12 stores an operating system or the program in the non-volatile memory area. The main memory 12 uses the volatile memory area as a work area where data is appropriately rewritten by the processing circuit 11. For example, the main memory 12 includes a read only memory (ROM) as the non-volatile memory area. For example, the main memory 12 includes a random-access memory (RAM) as the volatile memory area. The main memory 12 stores a program.

The auxiliary storage device 13 is equivalent to an auxiliary storage part of the server 1. The auxiliary storage device 13 is an element that configures the computer of the server 1. The auxiliary storage device 13 is an electric erasable programmable read-only memory (EEPROM) (registered trademark), a hard disc drive (HDD), a solid-state drive (SSD), or the like. The auxiliary storage device 13 stores the above-mentioned programs, data used by the processing circuit 11 when performing various processes, and data generated by the processing in the processing circuit 11. The auxiliary storage device 13 stores the above-mentioned programs.

The auxiliary storage device 13 includes a workflow storage area 130. The workflow storage area 130 stores information regarding a workflow. In this example, the workflow is a flow in which a generator generates document data and circulates it to a circulator (e.g., worker). The document data is draft data that is generated by a workflow drafter. For example, when the workflow is the generation of an application form, the document data indicates input data for the application form. The information regarding the workflow includes information such as a circulator, a circulation route, and authority. The circulator indicates a person who circulates the document data generated for each workflow. The information regarding the circulator is information that makes it possible to identify the circulator. The circulator includes a checker, an approver, and the like. The circulation route can be information indicating the order in which the circulator circulates the document data. The authority can be information indicating the authority of the worker or the circulator. The authority indicates operations that can be executed by the worker or the circulator. The operations that can be executed include, for example, at least one of generation, update, modification, approval, or return. The information regarding the workflow may include other information regarding the workflow. The information regarding the workflow may be set or updated by an administrator of the workflow service.

The auxiliary storage device 13 includes an execution history information storage area 131. The execution history information storage area 131 stores execution history information. The execution history information includes information such as user identification information, work history information, and an experience value. The execution history information can be updated as appropriate. The user identification information is identification information for uniquely identifying a user. The user refers to a user who uses the workflow service. The user identification information is, for example, a user ID. The work history information includes information indicating a work history for each workflow. For example, when a user is a generator and generates an application form, a work history for each workflow indicates a history related to input work on the application form. The work history includes information such as the date and time of work, a working time, and change history information. The date and time of work indicates the date and time when the worker performed the work for each workflow. The working time indicates a period of time required by the worker to perform the work for each workflow. The working time includes an input time for each input item (e.g., input, field) of each workflow. An input item indicates an item for which a generator of document data performs an input. The input item includes an item of a selection format using a pull-down menu or the like, and an item of a text input format that allows free description. The input item is also simply referred to as an item. The input item may indicate a confirmation item that requires confirmation by a confirmer. The working time may include a working time for each category of document data. The category is equivalent to a plurality of parts into which document data is divided. For example, when document data includes a plurality of items, the category may be set for each predetermined number of items. When document data includes a plurality of pages, the category may be set for each predetermined number of pages. The category may be set as appropriate by an administrator of the workflow service, or the like. In the following description, a working time or input time for each item may be read as a working time or input time for each category.

The change history information is information indicating a difference between input items before and after return. For example, when document data generated by a generator is returned to the generator by a worker of the succeeding order, the generator corrects the document data. The change history information includes information indicating a difference between information that is input by the generator before the return and information that is input, deleted, added, or updated (e.g., by the worker of the succeeding order) after the return. The change history information can include information indicating whether a change is made and information indicating the content of the change.

The change history information may include information regarding whether correction is required. The information regarding whether correction is required may include information indicated as an item that requires correction by a worker of the succeeding order after a generator such as a checker or an approver. The information regarding whether correction is required is, for example, feedback information from the worker of the succeeding order. The information indicated as an item that requires correction is also referred to as information that requires correction. For example, the information that requires correction may be a flag indicating that correction is required. For example, when document data generated by a generator includes an item that requires correction, the worker of the succeeding order clearly indicates the item (e.g., with a flag) and performs the return (e.g., returns the item to the generator). The worker of the succeeding order inputs information indicating the item that requires correction via an input device or the like of a user terminal of the worker of the succeeding order. The information indicating the item that requires correction may include information indicating the type of error. The type of error includes, for example, an input error, a forgotten input (e.g., missing inputs), and a forgotten change (e.g., missing edit). The input error indicates an error in the input item. The forgotten input indicates that an item to be input is not input. The forgotten change indicates that no change is made to the input item of the item that requires correction after the return.

The experience value indicates an experience value for each workflow. The experience value may be calculated based on a work history. The work history includes, for example, the number of tasks and a working time. For example, the server 1 may determine that a user is a skilled person when an experience value of the user is equal to or greater than a predetermined threshold value. The skilled person indicates a person who has sufficient experience (e.g., above the predetermined threshold value), knowledge, or skill to perform the work for the workflow. The server 1 may determine that a user is an inexperienced person when the experience value of the user is less than a predetermined threshold value. The inexperienced person indicates a person who does not have sufficient experience, knowledge, or skill to perform the work for the workflow. The inexperienced person may indicate a user who is prone to make input errors. The predetermined threshold value may be freely set by an administrator or the like. The experience value may be calculated based on an error rate for each workflow or each item. The error rate indicates, for example, the rate of errors made by an individual user. The error rate may be calculated based on the number of times return is performed with respect to the number of tasks of the user. The error rate may be calculated based on the number of input items in which errors occur with respect to the number of input items. The experience value may be calculated based on an error rate for all workflows that are executed. A method of calculating the error rate is not limited to the above.

The execution history information may include statistical information based on execution history information of a plurality of users. The statistical information includes, for example, information indicating an error rate for each item, an average input time for each item, and the like. The error rate indicates, for example, an error rate for all users for each workflow. The error rate is information based on information that requires correction. The error rate is, for example, a ratio of the number of items that require correction with respect to the number of inputs for each item. The error rate may be the ratio of the number of documents that are returned with respect to a total number of documents generated for each workflow. The error rate may include an input error rate, a forgotten (e.g., missing) input rate, and a forgotten change rate. The input error rate indicates the rate at which input errors occur. The forgotten input rate indicates the rate at which an input is forgotten. The forgotten change rate indicates the rate at which a change is forgotten after return. The average input time indicates an average value of an input time for each item. For example, when an input time for an item in a pull-down format is longer than the average time, it is considered that it takes time for selection. There is a high possibility of input errors occurring. When an input time for an item in a text input format is shorter than the average time, there is a possibility that necessary and sufficient description is not made. When an input time for an item in a text input format is longer than the average time, there is a possibility that unnecessary description is made (e.g., included, written). The statistical information may be updated each time execution history information is obtained.

The execution history information may include user attribute information. The user attribute information is information regarding a user's attributes. The user attribute information includes, for example, a department, team, and project to which the user belongs.

The execution history information may be updated as appropriate based on information acquired from the first user terminal 2. The execution history information may be updated as appropriate based on information acquired from the second user terminal 3.

The auxiliary storage device 13 may store the work status of a workflow. The work status indicates information such as a worker, input data, attached data, status, and the like. The worker is information that makes it possible to identify a user who performs work, such as a name and location. The input data indicates data such as text of necessary items input by the worker, and data such as text edited by the worker. The attached data indicates data such as necessary documents. The attached data includes data uploaded to a workflow service. The status indicates the status of the work. The work status includes, for example, drafting, applied for, waiting for a check, waiting for approval, settlement completed, and the like. The work status can be updated based on the operation (e.g., progress) of the worker.

The communication interface 14 includes various interfaces that connect the server 1 to other devices via the network in accordance with a predetermined communication protocol so that the server 1 can communicate with the other devices.

A hardware configuration of the server 1 is not limited to the above configuration. The server 1 allows the above-mentioned components to be omitted or changed and new components to be added as appropriate.

Parts implemented by the processing circuit 11 mentioned above will be described.

The processing circuit 11 implements one or more processors. The one or more processors may be included in an acquisition unit 110 (e.g., acquirer), a determination unit 111 (e.g., determiner), a support processing unit 112 (e.g., support processor), an update unit 113 (e.g., updater), and a communication processing unit 114 (e.g., communication processor). Each part implemented by the processing circuit 11 can also be referred to as each function. Each part implemented by the processing circuit 11 can also be referred to as being implemented by a control unit including the processing circuit 11 and the main memory 12. The processing circuit 11 is an example of a processing circuit.

The acquisition unit 110 acquires execution history information from the auxiliary storage device 13. The acquisition unit 110 may acquire execution history information from the first user terminal 2 via the communication interface 14. The acquisition unit 110 may acquire execution history information from the second user terminal 3 via the communication interface 14. In the following description, “acquire” may be read as “receive”.

The determination unit 111 performs a determination process related to work support. The determination unit 111 determines an item for which work support is to be performed, based on the execution history information. The item for which work support is to be performed includes an item with many errors, an item that requires attention during work, and an item that causes return. The item for which work support is to be performed includes an item for which a worker's attention is called. The work support indicates support performed to mitigate errors in input work, confirmation work, or approval work. The work support includes attention calling, changing a circulation route, and the like. The attention calling includes displaying a notice to call attention. Changing the circulation route includes adding a circulator. The determination unit 111 determines an item for which work support is to be performed based on an error rate. The determination unit 111 determines an item for which work support is to be performed based on a difference between an input time and an average input time. The item for which work support is to be performed is also referred to as a support item. The determination unit 111 may determine whether to perform work support based on an experience value of the user.

The support processing unit 112 performs a work support process. The work support process includes processing for changing workflow settings. Changing the workflow settings includes changing display settings. Changing the display settings includes processing for changing the display of an input image for inputting document data. The input image is an image for a generator to perform work. The generator may be a worker of the preceding order. The processing for changing the display of the input image includes displaying an item for which work support is to be performed in a display mode different from other items. The display mode includes a character color, a size, a font, an enclosed character, character attribute such as brightness or luminance, a background color, background brightness or luminance, a background pattern, a frame color, blinking display, and the like. The processing for changing the display of an input image includes displaying an attention calling notice (e.g., notification) for the item for which work support is to be performed. The attention calling notice includes, for example, an attention calling message such as “This is an item with many errors.” The attention calling notice may be a symbol, icon, sign, image, or the like indicating attention calling. The symbol or the like indicating attention calling may be an operator for displaying the attention calling message based on a user's operation. The user operation includes, for example, a touch operation, a click operation, a mouse over operation, and the like.

Changing the display settings includes processing for changing the display of a confirmation image for confirming document data. The confirmation image is an image for a confirmer to perform work. The confirmer may be a worker of the succeeding order. The processing for changing the display of the confirmation image includes displaying an item for which work support is to be performed in a display mode different from other items. The processing for changing the display of the confirmation image includes displaying an attention calling notice on the item for which work support is to be performed. The attention calling notice may be a notice similar to the attention calling notice in the input image. The attention calling notice may be a notice different from the attention calling notice in the input image. The processing for changing the display of the confirmation image includes displaying an attention calling notice on the confirmation image. The attention calling notice may be a notice based on the experience value of the generator of the document data. The notice (e.g., notification) based on the experience value includes, for example, an attention calling message such as “This is a document generated by an inexperienced person”.

The attention calling notice in the input image and the attention calling notice in the confirmation image may be the same notice or different notices.

Changing the workflow settings may include processing for changing a circulation route of document data. The processing for changing the circulation route includes processing for adding a circulator based on an experience value of the generator of the document data. The processing for adding the circulator includes, for example, adding a confirmer to the circulation route for intermediate checks when the generator is an inexperienced person. The processing for adding the circulator may include processing for adding a consultant.

The support processing unit 112 may perform the work support process based on the experience value of the user.

The update unit 113 updates the experience value of the user. The experience value may be updated based on a work history. For example, the update unit 113 may add a predetermined value to the experience value based on the completion of work by the user. The update unit 113 may add a different value to the experience value depending on a working time. For example, the update unit 113 may add additional points to the experience value when the working time of the worker is shorter than an average working time. The update unit 113 may add a different value to the experience value depending on whether return (e.g., of the document data) is performed. For example, the update unit 113 may add additional points to the experience value when return is not performed.

The communication processing unit 114 processes communication between the server 1 and other devices via the network. The communication processing unit 114 outputs various requests or various instructions to the first user terminal 2 and the second user terminal 3 via the communication interface 14. The communication processing unit 114 acquires various requests or various instructions from the first user terminal 2 and the second user terminal 3 via the communication interface 14.

### Display Example

An image displayed on a display device of the first user terminal 2 will be described.

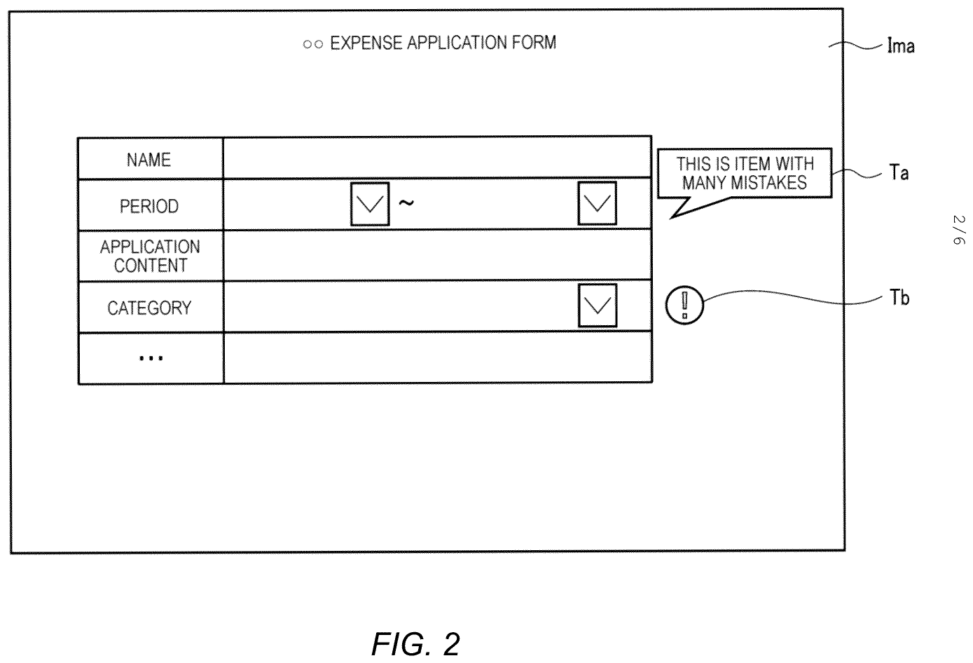

FIG. 2 is a diagram illustrating an example of an input image displayed on the first user terminal 2 according to the embodiment.

The user of the first user terminal 2 performs drafting work of a workflow via the first user terminal 2. In this example, the user of the first user terminal 2 generates an expense application form.

The user of the first user terminal 2 performs, for example, an operation to select a workflow to be worked on from a menu image displayed on the display device of the first user terminal 2. The workflow to be worked may also be referred to as a target workflow. The menu image may include, for example, a selection button that allows a target workflow to be selected from among a plurality of workflows. The menu image includes, for example, a plurality of workflows such as “travel expense application, expense application, facility use application, and report generation”. The selection button is an operator that allows a target workflow selection instruction to be input. The workflow selection instruction is an instruction to select a target workflow from among the plurality of workflows. In this example, the target workflow is “expense application”. The selection instruction is also referred to as an instruction to start a workflow. The user of the first user terminal 2 may select the selection button by a touch input or the like in accordance with the menu image. The selection instruction may include identification information that makes it possible to identify the user of the first user terminal 2.

The processing circuit 11 of the server 1 acquires the workflow selection instruction from the first user terminal 2. The processing circuit 11 outputs data for displaying an input image of the target workflow on the display device to the first user terminal 2 based on the selection instruction.

FIG. 2 illustrates an input image Ima displayed on the display device of the first user terminal 2.

The input image Ima includes input items. The input items include items such as a name, a period, an application content, and a category. Among the input items, the name item and the application content item are items in a text input format. Among the input items, the period item and the category item are items in a selection format (e.g., drop down menu).

The input image Ima includes an attention calling notice Ta and an attention calling notice Tb. In the example of FIG. 2, the attention calling notice Ta is an attention calling message. The attention calling notice Ta includes, for example, a message such as “This is an item with many errors”. The attention calling notice Ta may be a video. The attention calling notice Tb is a symbol indicating attention calling. For example, the display device may display an attention calling message (e.g., notification) when the attention calling notice Tb is selected by the user through a touch operation, a click operation, a mouse over operation, or the like. The first user terminal 2 may output the attention calling notice as a sound via a sound output device or the like.

In the example of FIG. 2, a case where an attention calling notice is displayed for each item for which work support is to be performed has been described, but is not limited thereto. The attention calling notice may be displayed in an upper portion, lower portion, or the like in the input image Ima.

The attention calling notice displayed in the confirmation image may be displayed in the same manner as in FIG. 2.

### Operation Example

A procedure of processing performed by the operation support system 100 will be described herein.

In the following description that focuses on the server 1, the server 1 may be read as the processing circuit 11. Similarly, in the following description that focuses on the first user terminal 2, the first user terminal 2 may be read as a processing circuit of the first user terminal 2. In the following description that focuses on the second user terminal 3, the second user terminal 3 may be read as a processing circuit of the second user terminal 3.

A processing procedure to be described below is merely an example, and each process may be changed as much as possible. In addition, steps may be omitted, replaced, or added to the processing procedure to be described below as appropriate depending on the embodiment.

In the following processing, it is assumed that the user (drafter) of the first user terminal 2 uses a workflow service provided by the server 1. The user of the first user terminal 2 selects a target workflow and performs drafting work. It is assumed that the user of the second user terminal performs check work on the document data generated by the user of the first user terminal 2.

The following processing will be described using an example in which the user of the first user terminal 2 submits an expense application. An expense application workflow includes drafting work performed by a drafter, check work performed by a checker, and approval work performed by an approver. The document data generated by the drafter is first circulated to the checker. The document data confirmed by the checker is then confirmed by the approver. In this example, a worker of the succeeding order of the drafter is the checker. A worker of the succeeding order of the checker is the approver. The check work and the approval work are also referred to as confirmation work. It is assumed that the target workflow is expense application.

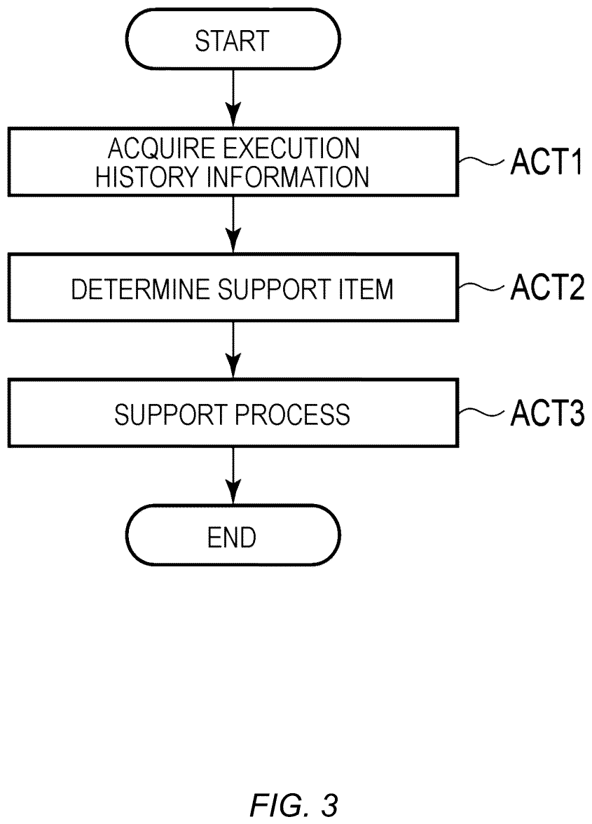

FIG. 3 is a flowchart illustrating an example of a procedure of information processing related to a support process performed by the server 1 according to the embodiment. In the example of FIG. 3, the support process for supporting input work performed by a drafter and a support process for supporting confirmation work performed by a confirmer such as a checker are described as examples.

The processing circuit 11 acquires execution history information (ACT1). ACT1 may be processing performed by the acquisition unit 110. In ACT1, for example, the processing circuit 11 acquires work history information from the execution history information storage area 131. The processing circuit 11 may acquire work history information of all users who have rights to access a target workflow. The processing circuit 11 may acquire statistical information regarding the target workflow.

The processing circuit 11 determines an item for which work support is to be performed based on the execution history information (ACT2). ACT2 may be processing performed by the determination unit 111. In ACT2, for example, the processing circuit 11 determines that an item with many errors is a work support item based on change history information. The processing circuit 11 may determine each input item to be the item with multiple errors based on information indicating whether a change is made, when the number of times indicating that a change is made for each input item exceeds a predetermined threshold value.

The processing circuit 11 may determine that the item with multiple errors is a work support item based on information that requires correction. The processing circuit 11 acquires the number of times each input item is determined to require correction by a worker of the succeeding order (confirmer). The processing circuit 11 may determine each input item to be the item with many errors when the number of times each input item is determined to require correction exceeds a predetermined threshold value. The processing circuit 11 may determine that an item with a high error rate is the item with many errors based on statistical information. The processing circuit 11 may determine an item to be the item with many errors when an error rate exceeds a predetermined threshold value. The predetermined threshold value can be set by an administrator (e.g., a user) or the like.

The processing circuit 11 may analyze an error pattern based on information indicating the content of the change and determine an item similar to the item with many errors to be a work support item. The error pattern includes, for example, many forgotten inputs in items in a selection format including a checkbox. The processing circuit 11 may determine, for example, an item in a similar selection format to be a work support item.

The processing circuit 11 may perform text analysis based on the information indicating the content of the change and determine an error pattern. For example, the processing circuit 11 may determine that multiple forgotten inputs of a participant's name in the “application content” item is an error pattern.

The processing circuit 11 may determine an item for which work support is to be performed based on a working time. For example, the processing circuit 11 may determine the item for which work support is to be performed based on a difference between an input time for each item (e.g., by a worker) and an average input time. The processing circuit 11 may determine that an item for which many input times deviating from the average input time for each item by more than a predetermined time are measured is an item for which work support is to be performed. For example, for an item with an average input time of 5 seconds, when the number of times an input time deviating 10 seconds or more is measured exceeds a predetermined threshold value, the processing circuit 11 may determine that the item is a work support item. The predetermined time may be appropriately set by an administrator or the like.

The processing circuit 11 performs a work support process for the item for which work support is to be performed (ACT3). ACT3 may be processing performed by the support processing unit 112. In ACT3, for example, the processing circuit 11 changes settings for the item for which work support is to be performed. The processing circuit 11 changes display settings for the item for which work support is to be performed to display an attention calling notice. For example, the processing circuit 11 changes display settings in an input image to display an attention calling notice. The processing circuit 11 may output information for displaying the attention calling notice to the first user terminal 2. The processing circuit 11 may change display settings to display an attention calling notice in a confirmation image. The processing circuit 11 may output information for displaying the attention calling notice to the second user terminal 3.

The processing circuit 11 may change the display settings to display a different attention calling notice depending on the type of error in the work support item. Specifically, when the work support item is an item with multiple forgotten inputs of a participant's name, the processing circuit 11 may change display settings of an input image to display information indicating multiple forgotten inputs of a participant's name. The information indicating many forgotten inputs of a participant's name includes, for example, a message such as “Please input a participant's name”. When a work support item is an item with a large number of errors of forgotten inputs of a participant's name, the processing circuit 11 may change display settings of a confirmation image to display the information indicating many forgotten inputs of a participant's name. The information indicating multiple forgotten inputs of a participant's name includes, for example, a message such as “Please confirm whether a participant's name is input”.

In addition, for example, the processing circuit 11 may change display settings to display a different attention calling notice depending on the content of an error in a work support item. Specifically, when the work support item is an item with many forgotten input errors, the processing circuit 11 may change display settings of an input image to display information indicating many forgotten inputs. The information indicating many forgotten inputs includes, for example, a message such as “This is an item with many forgotten inputs”. When the work support item is an item with multiple forgotten input errors, the processing circuit 11 may change display settings of a confirmation image to display information indicating many forgotten inputs.

According to this example, the server 1 can acquire execution history information of a workflow, determine an item for which work support is to be performed based on the execution history information, and perform a work support process for the item for which work support is to be performed. For example, the server 1 can collect and analyze the execution history information of the workflow, determine an item that is likely to cause an error to be a work support item, and perform processing for calling attention of an input worker for the work support item. In one example, the server 1 determines a work support item based on an error rate and performs a support process to display an attention calling notice for the work support items in an input image displayed on the first user terminal 2 and subjected to work by the input worker. For this reason, the server 1 can call attention of the user of the first user terminal 2 when the user performs an input on a work support item that is likely to cause an input error or the like. Thereby, the server 1 can reduce errors related to input work. In this manner, the server 1 can perform work support.

In addition, the server 1 determines a work support item based on the error rate and performs a support process to display an attention calling notice for the work support item in a confirmation image displayed on the second user terminal 3 and subjected to work by a confirmation worker. For this reason, the server 1 can call attention to the user of the second user terminal 3 when the user confirms the work support item that is likely to cause an input error. Thereby, the server 1 can perform support to easily find an input error during the confirmation work and mitigate the errors made by the input worker from being overlooked. In this manner, the server 1 can perform work support.

In another example, the server 1 analyzes an error pattern based on information indicating the content of changes and determines similar items to be work support items. For this reason, the server 1 can predict an item that is likely to cause an error and determine the item to be a work support item. Thereby, the server 1 can more appropriately call attention of the user. In this manner, the server 1 can perform work support.

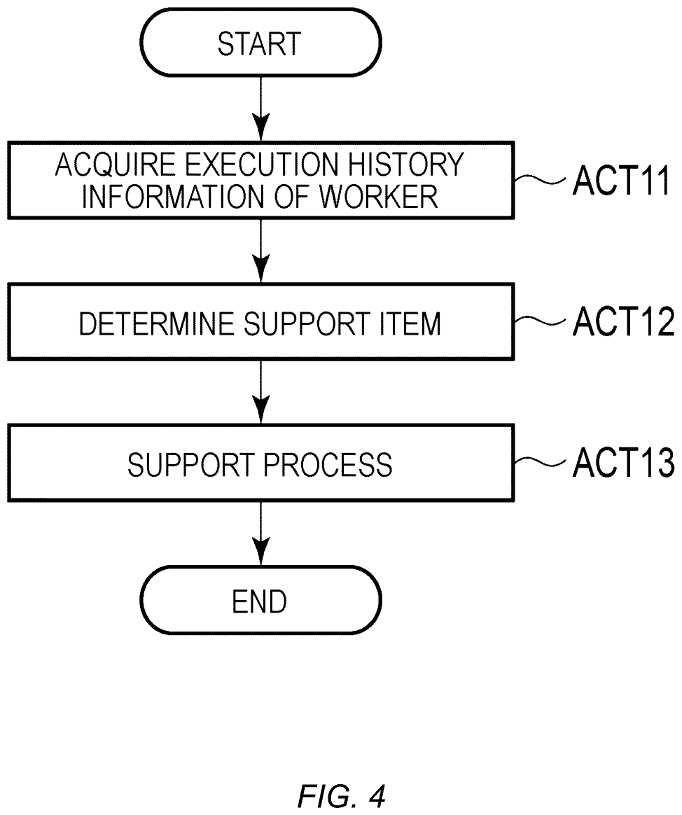

FIG. 4 is a flowchart illustrating another example of a procedure of information processing related to a support process performed by the server 1 according to the embodiment. In the example of FIG. 4, a support process for supporting a confirmation work performed by a confirmer such as a checker is described as an example. In the example of FIG. 4, a support process when document data is circulated to a worker of the succeeding order in accordance with a circulation route based on the completion of input work of the document data by a drafter is described as an example.

In the following example, a drafter is described as a worker or a worker of the preceding order, and a worker of the succeeding order is described as a confirmer. The drafter is an example of the user of the first user terminal 2. The confirmer is an example of the user of the second user terminal 3. The server 1 acquires execution history information from the first user terminal 2 based on the completion of the input work of the document data by the worker. The server 1 stores the execution history information of the user of the first user terminal 2 in the execution history information storage area 131.

The processing circuit 11 acquires the execution history information of the worker (ACT11). ACT11 may be processing performed by the acquisition unit 110 (e.g., the one or more processors). In ACT11, for example, the processing circuit 11 acquires the execution history information associated with user identification information of the worker from the execution history information storage area 131. The processing circuit 11 may acquire work history information of all users who have rights to access a target workflow. The processing circuit 11 may acquire statistical information regarding the target workflow.

The processing circuit 11 determines an item for which work support is to be performed based on the execution history information of the worker (ACT12). ACT12 may be processing performed by the determination unit 111. In ACT12, for example, the processing circuit 11 determines a work support item based on a difference between an input time for each item and an average input time. The processing circuit 11 may determine an item for which the worker's input time deviates from the average input time by more than a predetermined time (e.g., predetermined time threshold) to be a work support item. For example, the processing circuit 11 may determine an item for which the worker's input time is longer than the average input time by more than a predetermined time to be a work support item. The processing circuit 11 may determine an item for which the worker's input time is shorter than the average input time by more than a predetermined time to be a work support item. As a specific example, the processing circuit 11 may determine an item for which the worker's input time is longer than the average input time by 10 seconds or more to be a work support item. The processing circuit 11 may determine an item for which the worker's input time is shorter than the average input time by 10 seconds or more to be a work support item. The predetermined time may be appropriately set by an administrator or the like.

The processing circuit 11 performs a work support process for an item for which work support is to be performed (ACT13). ACT13 may be processing performed by the support processing unit 112. In ACT13, for example, the processing circuit 11 changes the settings of the target workflow of the worker of the succeeding order for the item for which work support is to be performed. The processing circuit 11 changes the display settings for the item for which work support is to be performed so that an attention calling notice is displayed on the confirmation image of the worker of the succeeding order. The attention calling notice includes, for example, a message such as “There may be an input error”.

The worker is not limited to the drafter but may be an intermediate worker such as a checker. The processing circuit 11 may determine the item for which work support is to be performed for a worker of the succeeding order of the intermediate worker based on the execution history information of the worker. The processing circuit 11 may perform a work support process on a confirmation image on which the worker of the succeeding order performs work.

According to this example, the server 1 according to the embodiment can determine an item for which work support is to be performed based on execution history information for each worker and perform a work support process for the item for which work support is to be performed. For example, the server 1 can determine an item for which work support is to be performed based on an input time for each item by an input worker. For this reason, the server 1 can determine an item for which there is a possibility of inappropriate input by comparing an input time with an average input time. Since the server 1 determines an item for which work support is to be performed for each input worker, the server 1 can perform appropriate work support on a worker of the succeeding order.

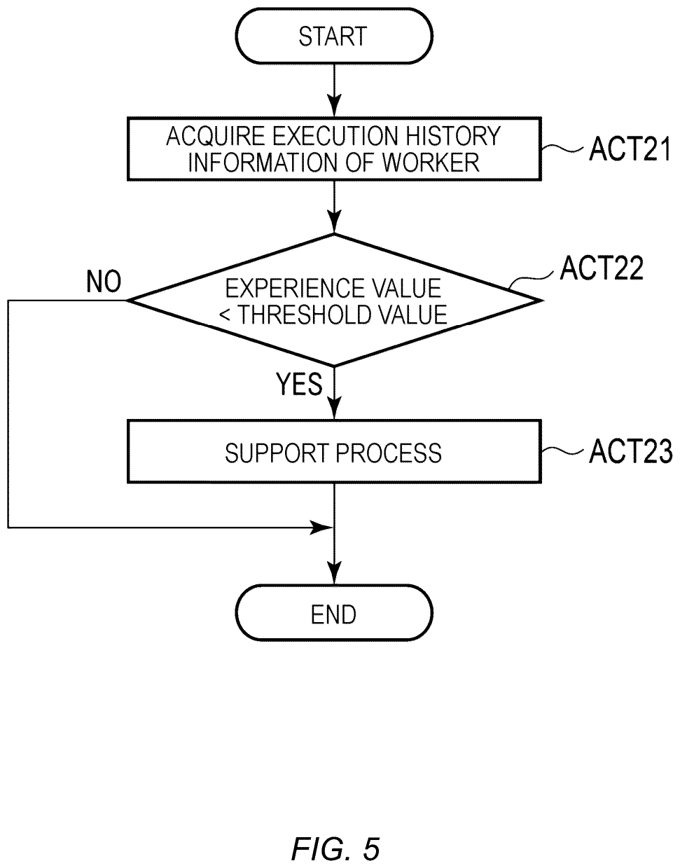

FIG. 5 is a flowchart illustrating another example of a procedure of information processing related to a support process performed by the server 1 according to the embodiment. In the example of FIG. 5, a support process for supporting confirmation work performed by a confirmer such as a checker is described as an example. In the example of FIG. 5, as in the example of FIG. 4, a support process when document data is circulated to a worker of the succeeding order in accordance with a circulation route based on the completion of input work of the document data by the drafter is described as an example.

In the following example, as in the example of FIG. 4, a drafter is described as a worker or a worker of the preceding order, and a worker of the succeeding order is described as a confirmer. The drafter is an example of the user of the first user terminal 2. The confirmer is an example of the user of the second user terminal 3. The server 1 acquires execution history information from the first user terminal 2 based on the completion of the input work of the document data by the worker. The server 1 stores the execution history information of the user of the first user terminal 2 in the execution history information storage area 131.

The processing circuit 11 acquires the execution history information of the worker as in ACT11 (ACT21). ACT21 may be processing performed by the acquisition unit 110. In ACT21, for example, the processing circuit 11 acquires the execution history information associated with user identification information of the worker from the execution history information storage area 131.

The processing circuit 11 determines whether an experience value of the worker is less than a predetermined threshold value (ACT22). ACT22 may be processing performed by the determination unit 111 (e.g., the one or more processors). In ACT22, for example, the processing circuit 11 acquires an experience value of a worker associated with a target workflow. The processing circuit 11 compares the experience value of the worker with the predetermined threshold value. The predetermined threshold value may be, for example, an average value of experience values of a plurality of users related to the target workflow. When the experience value is less than the predetermined threshold value, the worker's skill level is determined to be “unskilled”. The skill level being “unskilled” corresponds to being an inexperienced worker. When the experience value is equal to or greater than the predetermined threshold value, the worker's skill level is determined to be “experienced”. The skill level being “experienced” corresponds to being a skilled or experienced wore. When the experience value of the worker is less than the predetermined threshold value (ACT22: YES), the processing transitions from ACT22 to ACT23. When the experience value of the worker is greater than or equal to the predetermined threshold value (ACT22: NO), the processing ends.

The processing circuit 11 performs a work support process (ACT23). ACT23 may be processing performed by the support processing unit 112. In ACT23, for example, the processing circuit 11 changes the settings of the target workflow of the worker of the succeeding order. In one example, the processing circuit 11 changes the display settings to display an attention calling notice in the confirmation image of the worker of the succeeding order. The attention calling notice includes a message such as “The generator is an inexperienced person”. The processing circuit 11 may output information for displaying the attention calling notice to the second user terminal 3.

In another example, the processing circuit 11 changes the circulation route of the target workflow. For example, the processing circuit 11 adds a circulator to the circulation route of the target workflow. The processing circuit 11 may add a circulator that is set in advance for the target workflow to the circulation route. The processing circuit 11 may determine a circulator to be added to the circulation route based on attribute information of a worker, and the like. The circulator to be added to the circulation route may be, for example, an intermediate confirmer, an intermediate approver, or a consultant.

The worker is not limited to the drafter but may be an intermediate worker such as a checker. The processing circuit 11 may determine an item for which work support of a worker of the succeeding order of the intermediate worker is to be performed, based on the execution history information of the worker. The processing circuit 11 may perform a work support process on a confirmation image on which the worker of the succeeding order performs work.

According to this example, the server 1 can acquire an experience value of the user and perform a work support process based on the experience value. In one example, when an input worker is an inexperienced worker, the server 1 performs a support process to display an attention calling notice on a confirmation image on which a worker of the succeeding order performs confirmation work. For this reason, the server 1 can call attention to the user of the second user terminal 3 in response to the user confirming (e.g., checking) document data input by the inexperienced worker. Thereby, the server 1 can perform support so that the worker checking the document data can easily find errors and mitigate the errors made by the inexperienced worker from being overlooked (e.g., missed). In this manner, the server 1 can perform work support.

In another example, when the input worker is an inexperienced worker, the server 1 performs a support process to add a circulator to a circulation route. For this reason, the server 1 can automatically increase the number of people who confirm (e.g., check) document data that is input by the inexperienced worker. Thereby, the server 1 can perform support so that the worker (e.g., the checker) can easily find errors during the confirmation work and mitigate the errors made by the inexperienced worker from being overlooked. In this manner, the server 1 can perform work support.

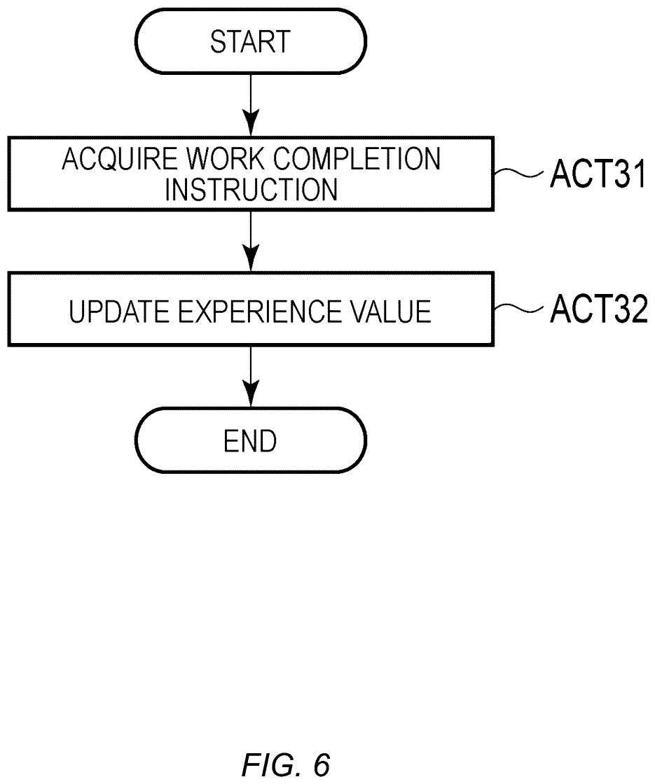

FIG. 6 is a flowchart illustrating an example of a procedure of information processing related to an experience value obtained by the server 1 according to the embodiment.

The following processing will be described taking as an example a case where the user of the first user terminal 2 completes work. It is assumed that the user of the first user terminal 2 is a drafter. The user of the first user terminal 2 outputs a work completion instruction to the server 1 based on the completion of input work of a target workflow. The user of the first user terminal 2 outputs the completion instruction to the server 1, for example, by selecting a completion button or the like included in an input image displayed on a display device of the first user terminal 2. The completion button is an operator that allows the work completion instruction to be input. The completion instruction may include identification information that makes it possible to identify the user of the first user terminal 2.

The processing circuit 11 acquires the completion instruction from the first user terminal 2 (ACT31). ACT31 may be processing performed by the acquisition unit 110. In ACT31, for example, the processing circuit 11 circulates document data to a worker of the succeeding order based on the acquisition of the completion instruction. For example, the processing circuit 11 specifies a worker of the succeeding order in accordance with the circulation route of the target workflow. The processing circuit 11 may notify the worker of the succeeding order. The worker of the succeeding order may access a workflow service and start work based on the notice.

The processing circuit 11 updates the experience value (ACT32). ACT32 may be processing performed by the update unit 113. In ACT32, for example, the processing circuit 11 updates the experience value of the user of the first user terminal 2 based on the completion of the work by the user of the first user terminal 2. The processing circuit 11 adds a predetermined value to the experience value of the user associated with the workflow for which the work is completed. The processing circuit 11 updates the execution history information stored in the execution history information storage area 131 based on the update of the experience value.

According to this example, the server 1 can update the experience value based on the completion of the work of the worker. Thereby, the server 1 can appropriately perform work support using the experience value.

### Other Embodiments

The above-mentioned embodiment is described using a workflow service as an example but is not limited thereto. The above-mentioned embodiment can also be applied to services such as SNS where a plurality of users communicate with each other or share information. In this case, a workflow can be read as a topic. The server 1 determines a work support item for each topic and performs a work support process.

The information processing device may be implemented by a single device such as the server 1 or may be implemented by a plurality of devices with distributed functions. In the latter case, the information processing device includes the meaning of an information processing system configured with a plurality of devices.

The above-mentioned embodiment may be applied not only to a device but also to a method executed by the device. The above-mentioned embodiment may be applied to a program capable of causing a computer of a device to execute each function. The above-mentioned embodiment may be applied to a recording medium that stores the program. The above-mentioned embodiment may be applied not only to a system but also to a method executed by a plurality of elements included in the system.

A processing circuit includes one or more circuits that implement a plurality of processes by a plurality of functions. For example, the circuit is a processor, an application specific integrated circuit (ASIC), or a field-programmable gate array (FPGA), but is not limited thereto.

Each of one or more circuits that configure the processing circuit executes one or more of processes among the plurality of processes. When the processing circuit is configured with a single circuit, the single circuit executes all of the plurality of processes. When the processing circuit is configured with a plurality of circuits, each of the plurality of circuits executes some of the plurality of processes. Some of the plurality of processes may be one of the plurality of processes or two or more of the plurality of processes. When the processing circuit is configured with a plurality of circuits, the plurality of circuits may be included in one device or may be distributed to a plurality of devices.

The program may be transferred in a state of being stored in a device or transferred in a state of not being stored in a device. In the latter case, the program may be transferred via a network or transferred in a state of being recorded on a recording medium. The recording medium is a non-transitory tangible medium. The recording medium is a computer-readable medium. The recording medium may be a medium, such as a CD-ROM or a memory card, which can store a program and being readable by a computer, and the form of the recording medium does not matter.

While certain embodiments have been described, these embodiments have been presented by way of example only and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In short, this invention is not limited to the above-mentioned embodiment as it is, and in the implementation stage, the components can be modified and embodied without departing from the gist of the invention. Furthermore, various inventions can be formed by appropriately combining a plurality of components disclosed in the above-mentioned embodiment. For example, some components may be deleted from all of the components shown in the embodiment. Furthermore, components from different embodiments may be appropriately combined.

### Supplementary Note

The above-mentioned embodiment may be expressed as follows.

(1) An information processing device including:
an acquisition unit configured to acquire execution history information of a workflow;
a determination unit configured to determine an item for which work support is to be performed based on the execution history information; and
a support processing unit configured to perform a work support process for the item.

(2) The information processing device according to (1), in which the determination unit determines the item for which work support is to be performed based on an error rate.

(3) The information processing device according to (1), in which the determination unit determines the item for which work support is to be performed based on a difference between an input time and an average input time.

(4) The information processing device according to (1), in which
the acquisition unit acquires an experience value of a user, and
the support processing unit performs the work support process based on the experience value.

(5) An information processing method including:
acquiring execution history information of a workflow; determining an item for which work support is to be performed based on the execution history information; and
performing a work support process for the item.

(6) An information processing system including:
an information processing terminal; and
an information processing device,
in which the information processing device includes
an acquisition unit that acquires execution history information of a workflow;
a determination unit that determines an item for which work support is to be performed based on the execution history information; and
a support processing unit that performs a work support process for the item in the information processing terminal.

What is claimed is:

1. An information processing device comprising one or more processors to:
acquire execution history information of a workflow;
determine an item for which work support is to be performed based on the execution history information; and
perform a work support process for the item.

2. The information processing device according to claim 1, wherein the one or more processors determine the item for which work support is to be performed based on an error rate.

3. The information processing device according to claim 1, wherein the one or more processors determine the item for which work support is to be performed based on a difference between an input time and an average input time.

4. The information processing device according to claim 1, wherein the one or more processors
acquire an experience value of a user, and
perform the work support process based on the experience value.

5. An information processing method comprising:
acquiring, by one or more processors, execution history information of a workflow;
determining, by the one or more processors, an item for which work support is to be performed based on the execution history information; and
performing, by the one or more processors, a work support process for the item.

6. The information processing method according to claim 5, comprising determining, by the one or more processors, the item for which work support is to be performed based on an error rate.

7. The information processing method according to claim 5, comprising determining, by the one or more processors, the item for which work support is to be performed based on a difference between an input time and an average input time.

8. The information processing method according to claim 5, comprising:
acquiring, by the one or more processors, an experience value of a user, and
performing, by the one or more processors, the work support process based on the experience value.

9. An information processing system comprising:
an information processing terminal; and
an information processing device,
wherein the information processing device includes one or more processors to:
acquire execution history information of a workflow;
determine an item for which work support is to be performed based on the execution history information; and
perform a work support process for the item in the information processing terminal.

10. The information processing system according to claim 9, wherein the one or more processors determine the item for which work support is to be performed based on an error rate.

11. The information processing system according to claim 9, wherein the one or more processors determine the item for which work support is to be performed based on a difference between an input time and an average input time.

12. The information processing system according to claim 9, wherein the one or more processors
acquire an experience value of a user, and
perform the work support process based on the experience value.
